(19) United States
(12) Patent Application Publication
(10) Pub. No.: US 2016/0159696 A1
(43) Pub. Date: Jun. 9, 2016

(54) METHOD OF MANUFACTURING CERAMIC ASSEMBLY

(71) Applicant: Asahi Glass Company, Limited, Chiyoda-ku (JP)

(72) Inventors: Fumiaki SAITO, Chiyoda-ku (JP); Taro Uchiyama, Beaverton, OR (US)

(73) Assignee: Asahi Glass Company, Limited, Chiyoda-ku (JP)

(21) Appl. No.: 14/560,620

(22) Filed: Dec. 4, 2014

(51) Int. Cl. C04B 37/00

(52) U.S. Cl. CPC C04B 37/001

(57) ABSTRACT

A method of manufacturing a ceramic assembly by assembling a plurality of green ceramic components, includes: subsequently mounting each of the plurality of green ceramic components on a heat resistant substrate made of a heat resistant material; bonding the plurality of green ceramic components mounted on the substrate with each other; and introducing a ceramic assembly formed by the plurality of green ceramic components bonded with each other into a sintering furnace while being mounted on the heat resistant substrate.

### BACKGROUND OF THE INVENTION

1. Field of the Invention

The present invention relates to a method of manufacturing a ceramic assembly.

2. Description of the Related Art

For example, a sheet glass is manufactured by processing molten glass into a glass ribbon with a desired thickness, and then annealing the glass ribbon while transferring the glass ribbon by a transfer roller in a sheet glass manufacturing apparatus. Further, when manufacturing the sheet glass, a test is conducted to detect the existence of defect such as micro flaws or air voids at the surface of or inside the sheet glass. Japanese Laid-open Patent Publication No. H11-337324 discloses such a sheet glass test system, for example.

In such a sheet glass test system, an inside test area and a surface test area are provided at a transfer direction of a band-shaped sheet glass. Further, at the inside test area, light equipment is provided under the sheet glass and a plurality of cameras are aligned above the sheet glass in a width direction that is perpendicular to the transfer direction. At the surface test area, a light source is provided in the vicinity of the surface of the sheet glass and cameras are provided diagonally in front of the sheet glass and diagonally in an upward direction of the sheet glass.

However, in accordance with an increase in the size of the sheet glass, the size of a housing in which the cameras are mounted also increases. Meanwhile, in order to increase the test accuracy provided by the cameras, it is required for the housing in which the cameras are mounted to have sufficient rigidity while being lightweight in order to efficiently move the housing or assemble the housing.

Thus, in response to a request to the requirement of rigidity and lightning as described above, it has been studied to manufacture a housing made of ceramics.

However, when manufacturing a housing made of ceramics, it is difficult to make hole portions in the housing for mounting cameras by grinding the monolithic housing that has a size large enough to correspond to the large size sheet glass due to a limitation of a length of a tool or cost. Further, it is also difficult to make a ceramic assembly by accurately bonding a plurality of green ceramic components after machining the plurality of green ceramic components.

Japanese Laid-open Patent Publication No. 2007-10235 discloses a ceramic jig for heat treatment that is bridged at a plurality of positions in order to prevent deformation or to increase uniformity during the heat treatment when sintering large size ceramics, for example. The jig for heat treatment has an open structure so that heat is not accumulated in the jig even when sintering large size ceramics that cause heat generation, by activating the flow of gas.

This sintering jig may be used for sintering monolithic ceramics such as a honeycomb. However, it is difficult to mount a large size ceramics that are provided with hole structures such as hole portions for mounting cameras that extend in complicated directions after bonding elements of large size ceramics and while maintaining its accuracy, before sintering. In particular, for a complex structure having a height of more than or equal to 300mm, it is very difficult to suppress deformation of ceramics in the vertical direction to be less than or equal to 1 mm due to the weight of the ceramics. Further, although an example is disclosed in which a plurality of holes are provided in the sintering jig, the sintering jig cannot be used to determine a position of a large size green component (a large size ceramic component before being sintered) or to prevent the deformation of the component because a positional relationship with the component is not held.

### SUMMARY OF THE INVENTION

The present invention is made in light of the above problems, and provides a method of manufacturing a ceramic assembly capable of substantially resolving one or more of the above problems.

According to an embodiment, there is provided a method of manufacturing a ceramic assembly by assembling a plurality of green ceramic components, including subsequently mounting each of the plurality of green ceramic components on a heat resistant substrate made of a heat resistant material; bonding the plurality of green ceramic components mounted on the substrate with each other; and introducing a ceramic assembly formed by the plurality of green ceramic components bonded with each other into a sintering furnace while being mounted on the heat resistant substrate.

### BRIEF DESCRIPTION OF THE DRAWINGS

Other objects, features and advantages of the present invention will become more apparent from the following detailed description when read in conjunction with the accompanying drawings.

FIG. 1 is an exploded perspective view illustrating an example of an assembly jig that is used in a method of manufacturing a ceramic assembly of an embodiment;

FIG. 2 is a perspective view illustrating an example of the assembly jig used in the method of manufacturing the ceramic assembly of the embodiment;

FIG. 3 is a partially cross-sectioned front view illustrating an assembling step 1 of the ceramic assembly;

FIG. 4 is a partially cross-sectioned side view illustrating the assembling step 1 of the ceramic assembly;

FIG. 5 is a partially cross-sectioned front view illustrating an assembling step 2 of the ceramic assembly;

FIG. 6 is a partially cross-sectioned side view illustrating an assembling step 3 of the ceramic assembly;

FIG. 7 is a partially cross-sectioned front view illustrating an assembling step 4 of the ceramic assembly;

FIG. 8 is a partially cross-sectioned side view illustrating an assembling step 5 of the ceramic assembly;

FIG. 9 is a perspective view illustrating the ceramic assembly when the assembling steps are completed;

FIG. 10 is a flowchart for explaining steps of the method of manufacturing the ceramic assembly;

FIG. 11 is a perspective view illustrating an alternative example 1 of the assembly jig that is used in the method of manufacturing the ceramic assembly;

FIG. 12 is a partially cross-sectioned front view illustrating a holding member that is applied to a carbon fiber reinforced SiC substrate of an alternative example 1;

FIG. 13 is a partially cross-sectioned side view illustrating a structure of a holding member that is applied to a carbon fiber reinforced SiC substrate of the alternative example 1;

FIG. 14 is a flowchart for explaining steps of the method of manufacturing the ceramic assembly of the alternative example 1;

FIG. 15 is a perspective view illustrating an assembly jig that is used in the method of manufacturing a ceramic assembly of an alternative example 2;

FIG. 16 is a partially cross-sectioned front view illustrating a holding member that is applied to a carbon substrate of the alternative example 2; and

FIG. 17 is a partially cross-sectioned side view illustrating the holding member that is applied to the carbon substrate of the alternative example 2.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

In this embodiment, a method of manufacturing a ceramic assembly is explained that is used as a housing of a defect test system for detecting defects in a sheet glass in manufacturing the sheet glass, as an example.

First, the structure of an assembly jig that is used in the method of manufacturing the ceramic assembly of the embodiment is explained. Then, the method of manufacturing the ceramic assembly using the assembly jig is explained.

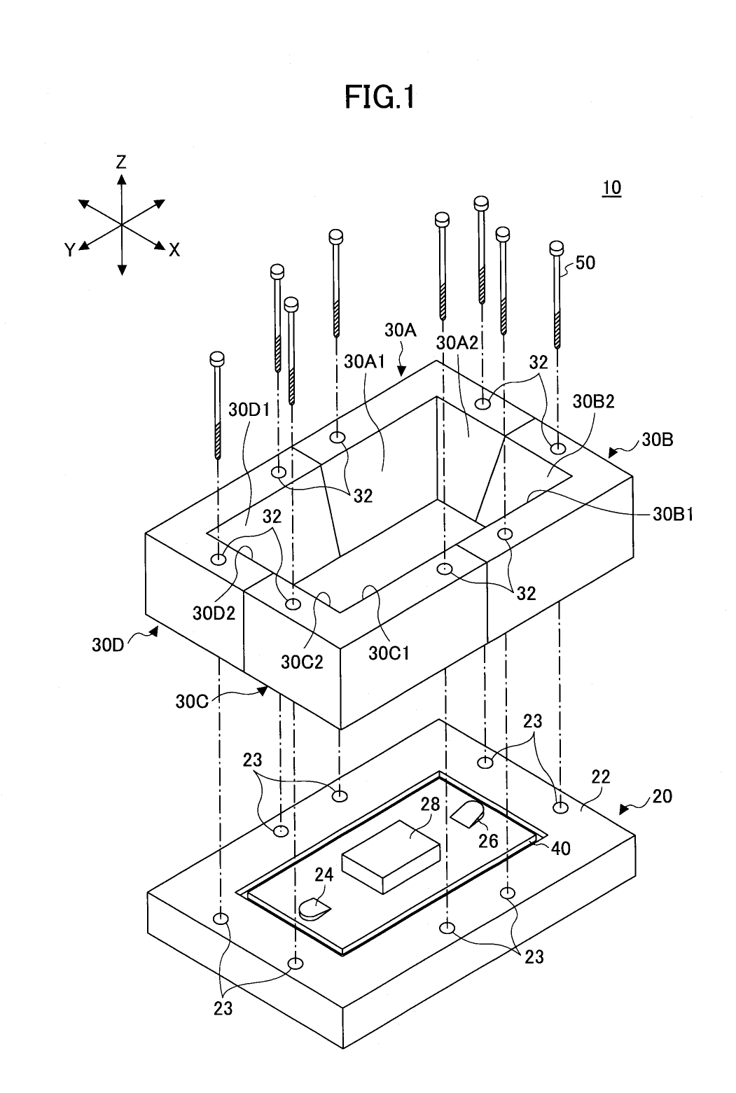

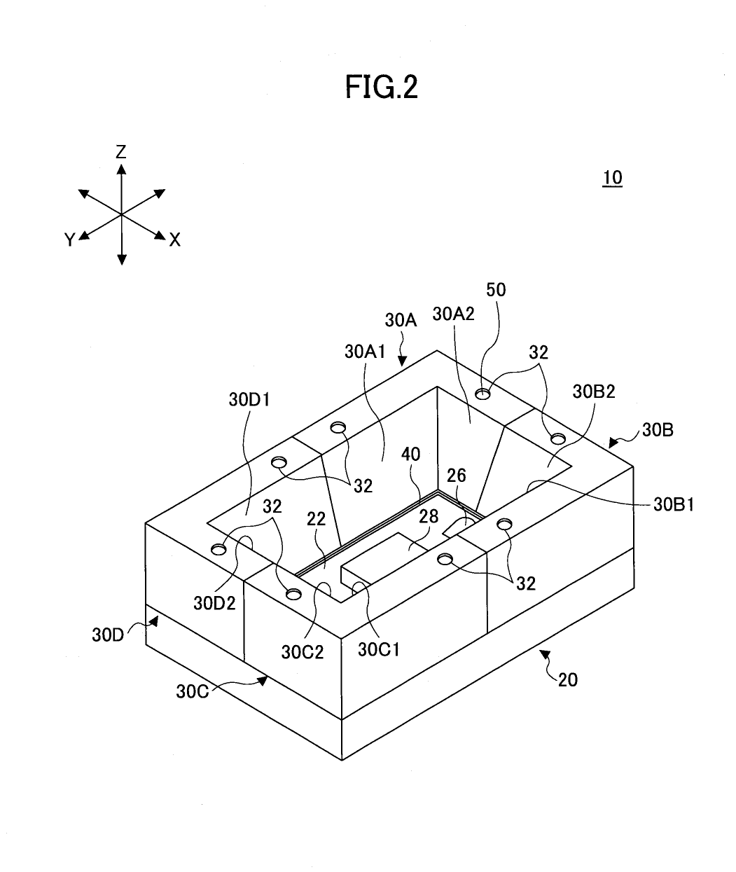

FIG. 1 is an exploded perspective view illustrating an example of an assembly jig 10 that is used in the method of manufacturing the ceramic assembly of the embodiment. FIG. 2 is a perspective view illustrating an example of the assembly jig 10 that is used in the method of manufacturing the ceramic assembly of the embodiment.

As illustrated in FIG. 1 and FIG. 2, the assembly jig 10 includes a carbon substrate 20 and a plurality of carbon holding members 30A to 30D. The carbon substrate 20 and the carbon holding members 30A to 30D are machined in a tabular shape from sintered carbon at a high temperature. Thus, the carbon substrate 20 and the carbon holding members 30A to 30D have a heat resistance property capable of resisting high temperatures of heating temperature (more than or equal to 1400° C., for example) in a sintering furnace and are capable of being introduced into the sintering furnace.

The carbon substrate 20 is formed in a tabular shape. The carbon substrate 20 is provided with screw holes 23 for fixing the carbon holding members 30A to 30D and positioning portions 24, 26 and 28 at an upper surface 22. Further, a pocket (groove) 40 is provided at the upper surface 22 of the carbon substrate 20 for receiving binder solution that bonds green ceramic components with each other. The pocket 40 is formed to have a rectangular frame shape surrounding an assembling area at which a ceramic assembly is to be mounted.

Each of the carbon holding members 30A to 30D is provided with a plurality of bolt insertion holes 32 that are in communication with the screw holes 23 of the carbon substrate 20. The position of each of the carbon holding members 30A to 30D with respect to the carbon substrate 20 is determined when external threads of bolts 50, that are inserted in the bolt insertion holes 32, are screwed in the screw holes 23. Each of the bolts 50 is made of carbon, and has a heat resistance property capable of resisting the heating temperature (more than or equal to 1400° C., for example) when placed in the sintering furnace.

When bottom surfaces of the carbon holding members 30A to 30D are fixed to the upper surface 22 of the carbon substrate 20, a frame body that extends along the four edges of the carbon substrate 20 is formed. Further, the carbon holding members 30A to 30D are formed to have first inclined surfaces 30A1, 30B1, 30C1 and 30D1 and second inclined surfaces 30A2, 30B2, 30C2 and 30D2 formed inside to the assembly jig 10 for supporting green ceramic components as will be explained later. Inside the assembly jig 10 formed by the first inclined surface 30A1 to 30D1 and the second inclined surface 30A2 to 30D2, there is defined an assembling area in which green ceramic components are assembled.

The first inclined surfaces 30A1 to 30D1 are inclined with respect to a Y-Z plane at which a Y direction and a Z direction cross. The second inclined surfaces 30A2 to 30D2 are inclined with respect to an X-Z plane at which an X direction and the Z direction cross. Thus, deformation in the Z direction and directions perpendicular to the Z direction (the X direction or the Y direction) that may occur during drying or sintering after bonding the ceramic assembly can be suppressed and an assembling accuracy after sintering can be maintained at a high degree of accuracy.

Here, inclined angles of the first inclined surfaces 30A1 to 30D1 and the second inclined surfaces 30A2 to 30D2 with respect to the horizontal direction may be set at an arbitral angle within a range of 1° to 89°.

Next, the method of assembling the ceramic assembly using the assembly jig 10 as described above is explained.

### (Step 1)

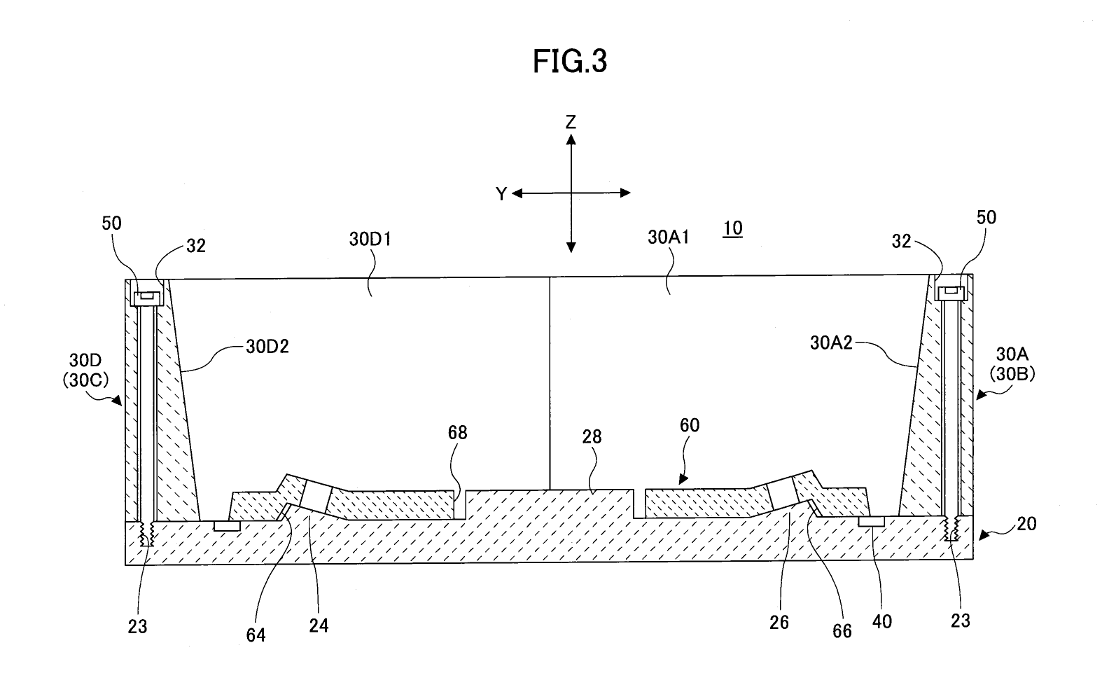

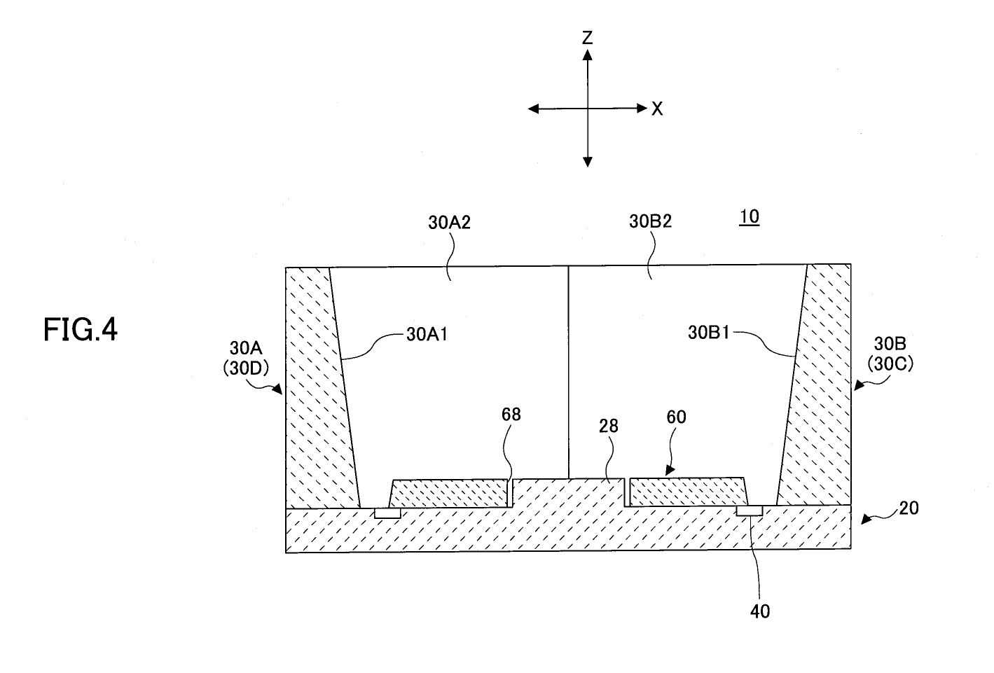

FIG. 3 is a partially cross-sectioned front view illustrating an assembling step 1 of the ceramic assembly. FIG. 4 is a partially cross-sectioned side view illustrating the assembling step 1 of the ceramic assembly.

As illustrated in FIG. 3 and FIG. 4, a first green ceramic component 60 is mounted on the upper surface 22 of the carbon substrate 20. The first green ceramic component 60 is provided with concave portions 64 and 66 at its bottom surface respectively corresponding to the positioning portions 24 and 26 and a through hole 68 corresponding to the positioning portion 28. Thus, the first green ceramic component 60 is positioned at a predetermined position on the carbon substrate 20 by fitting the concave portions 64 and 66 and the through hole 68 with the positioning portions 24, 26 and 28 of the carbon substrate 20, respectively. With this configuration, the periphery of the first green ceramic component 60 is positioned at a center position of the pocket 40.

As the first green ceramic component 60 shrinks in a sintering step, the concave portions 64 and 66 and the through hole 68 are formed to have a predetermined space with respect to the positioning portions 24, 26 and 28, respectively, for adjusting to the shrinkage so that the first green ceramic component 60 can be fitted to the carbon substrate 20 at the right position after being sintered.

Further, the concave portions 64 and 66 are provided with mounting surfaces to which cameras, as components to be mounted, are mounted. Each of the mounting surfaces has an inclined surface that is a combination of an inclined angle in the X direction and an inclined angle in the Y direction corresponding to an mounting angle of each of the cameras. Here, each of the inclined angles of the mounting surface in the X direction and the Y direction may be set at an arbitral angle in accordance with the mounting angle of each of the cameras, for example.

### (Step 2)

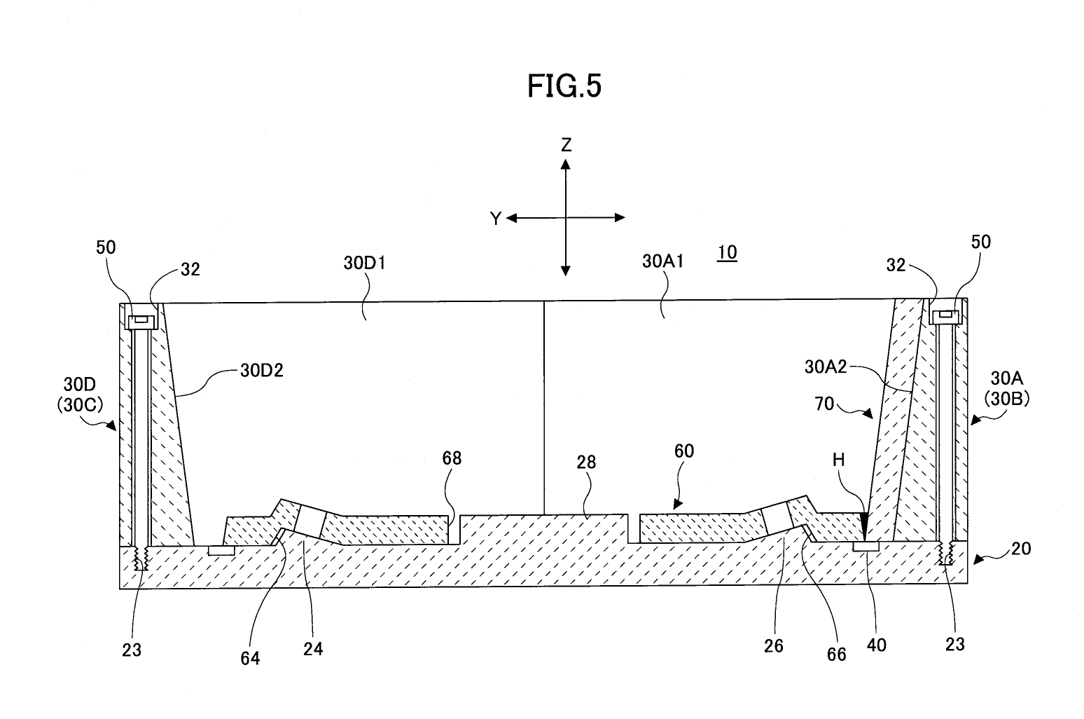

FIG. 5 is a partially cross-sectioned front view illustrating an assembling step 2 of the ceramic assembly. As illustrated in FIG. 5, a second green ceramic component 70 is mounted on the upper surface 22 of the carbon substrate 20 and the inclined surfaces 30A2 and 30B2 of the carbon holding members 30A and 30B. As the second green ceramic component 70 is held at the inclined surfaces 30A2 and 30B2 of the carbon holding members 30A and 30B, the second green ceramic component 70 is stably held at a relative position with respect to the first green ceramic component 60. With this configuration, an assembling position of the first green ceramic component 60 and the second green ceramic component 70 can be set with a high degree of accuracy.

Subsequently, binder solution H is applied between the first green ceramic component 60 and the second green ceramic component 70. The binder solution may be mixed solution for bonding including ceramic material powder and a binder, for example. After applying the binder solution H between the first green ceramic component 60 and the second green ceramic component 70, the binder solution H is dried to bond the first green ceramic component 60 and the second green ceramic component 70. At this time, a part of the binder solution H drops in the pocket 40 provided at a position lower than the first green ceramic component 60 and the second green ceramic component 70. Thus, the first green ceramic component 60 and the second green ceramic component 70 are prevented from being bonded to the carbon substrate 20.

### (Step 3)

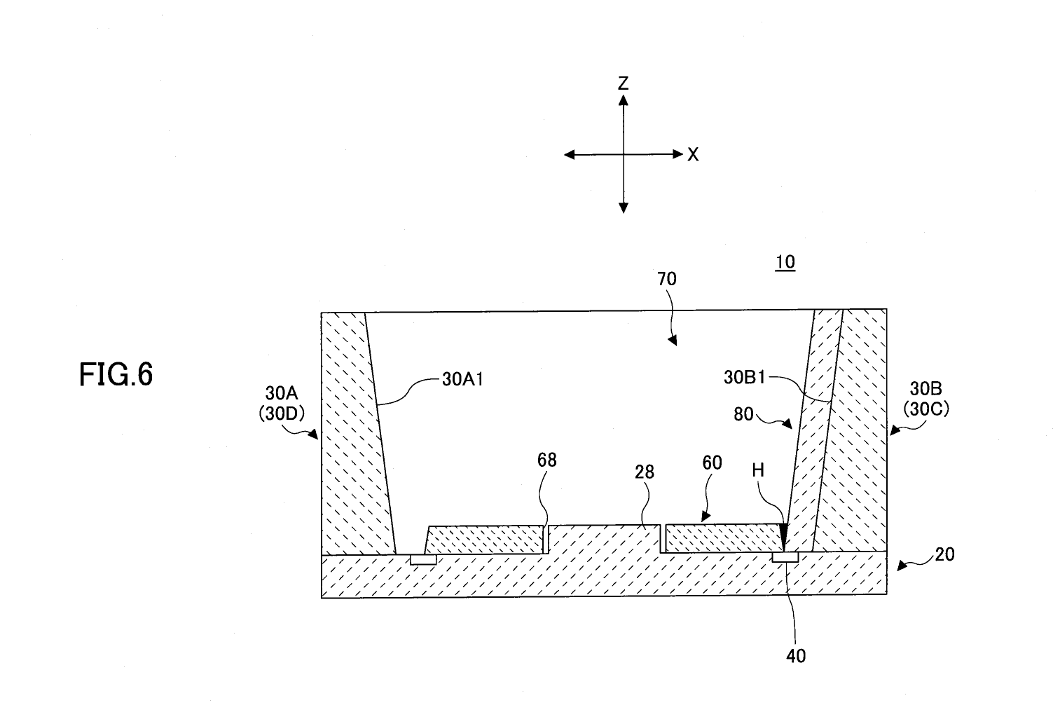

FIG. 6 is a partially cross-sectioned side view illustrating an assembling step 3 of the ceramic assembly. As illustrated in FIG. 6, a third green ceramic component 80 is mounted on the upper surface 22 of the carbon substrate 20 and the inclined surfaces 30B1 and 30C1 of the carbon holding members 30B and 30C. As the third green ceramic component 80 is held at the inclined surfaces 30B1 and 30C1 of the carbon holding members 30B and 30C, the third green ceramic component 80 is stably held at a relative position with respect to the first green ceramic component 60. With this configuration, an assembling position of the first green ceramic component 60 and the third green ceramic component 80 can be set with a high degree of accuracy.

Subsequently, the binder solution H is applied between the first green ceramic component 60 and the third green ceramic component 80, and between the second green ceramic component 70 and the third green ceramic component 80. After applying the binder solution H between the first green ceramic component 60 and the third green ceramic component 80, and between the second green ceramic component 70 and the third green ceramic component 80, the binder solution H is dried to bond the first to third green ceramic components 60 to 80.

At this time, a part of the binder solution H drops in the pocket 40 provided at a position lower than the first to third green ceramic components 60 to 80. Thus, the first to third green ceramic components 60 to 80 are prevented from being bonded to the carbon substrate 20.

### (Step 4)

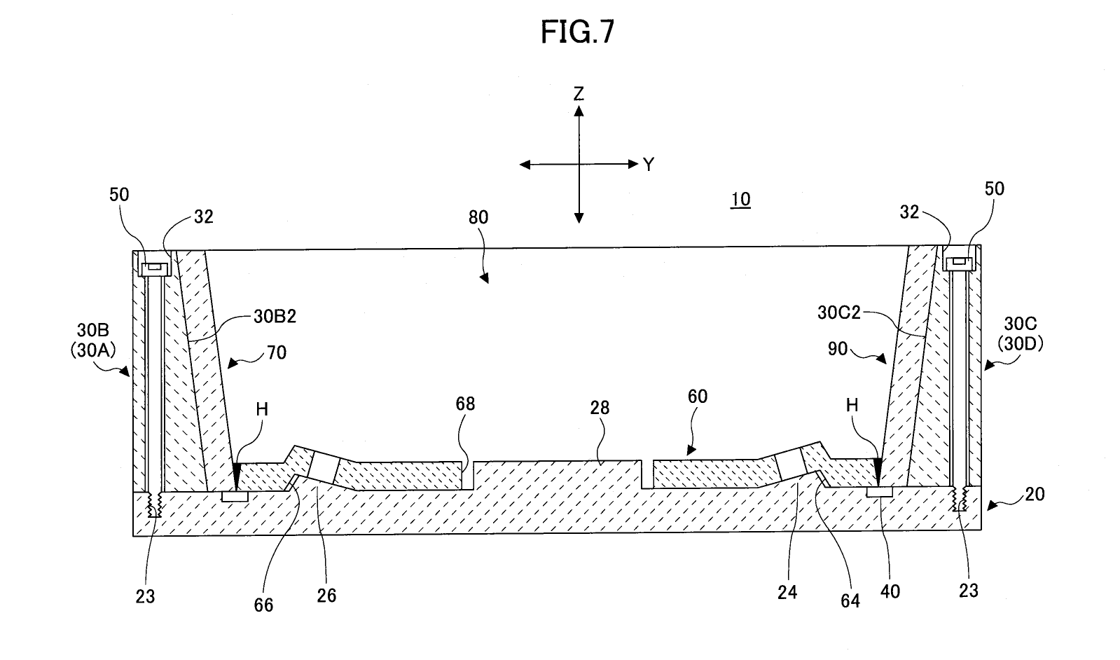

FIG. 7 is a partially cross-sectioned front view illustrating an assembling step 4 of the ceramic assembly. FIG. 7 is a view shown from an opposite direction from a direction seeing in FIG. 3 and FIG. 5. As illustrated in FIG. 7, a fourth green ceramic component 90 is mounted on the upper surface 22 of the carbon substrate 20 and the inclined surfaces 30C2 and 30D2 of the carbon holding members 30C and 30D. As the fourth green ceramic component 90 is held at the inclined surfaces 30C2 and 30D2 of the carbon holding members 30C and 30D, the fourth green ceramic component 90 is stably held at a relative position with respect to the first green ceramic component 60. With this configuration, an assembling position of the first green ceramic component 60 and the fourth green ceramic component 90 can be set with a high degree of accuracy.

Subsequently, the binder solution H is applied between the first green ceramic component 60 and the fourth green ceramic component 90, and between the third green ceramic component 80 and the fourth green ceramic component 90. After applying the binder solution H between the first green ceramic component 60 and the fourth green ceramic component 90, and between the third green ceramic component 80 and the fourth green ceramic component 90, the binder solution H is dried to bond the first, third and fourth green ceramic components 60, 80 and 90.

At this time, a part of the binder solution H drops in the pocket 40 provided at a position lower than the first, third and fourth green ceramic components 60, 80 and 90. Thus, the first, third and fourth green ceramic components 60, 80 and 90 are prevented from being bonded to the carbon substrate 20.

### (Step 5)

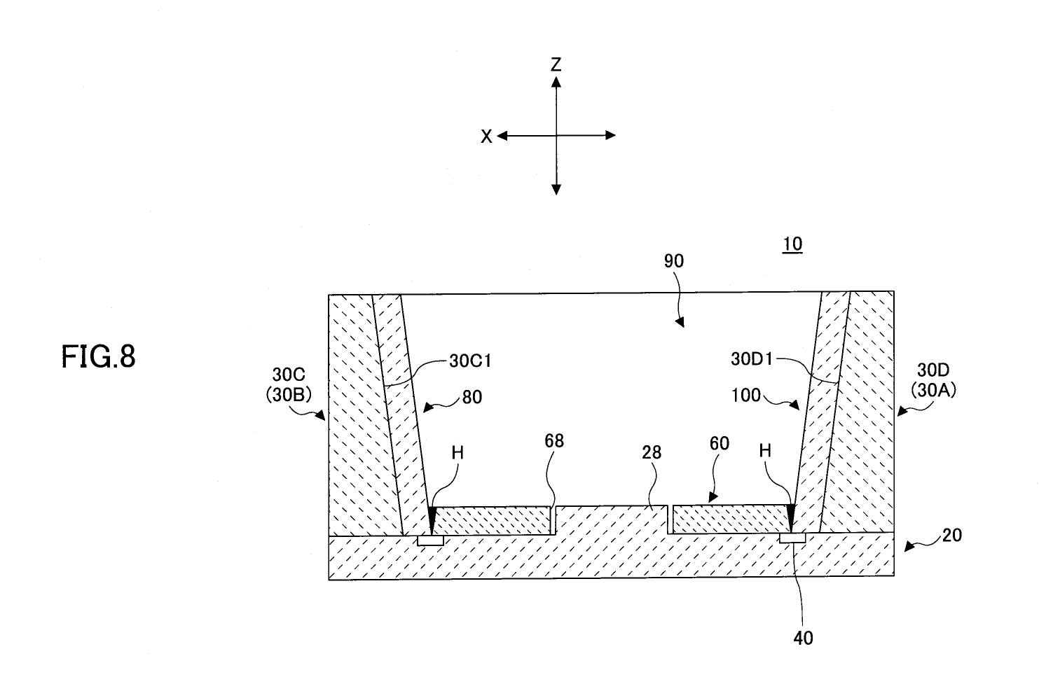

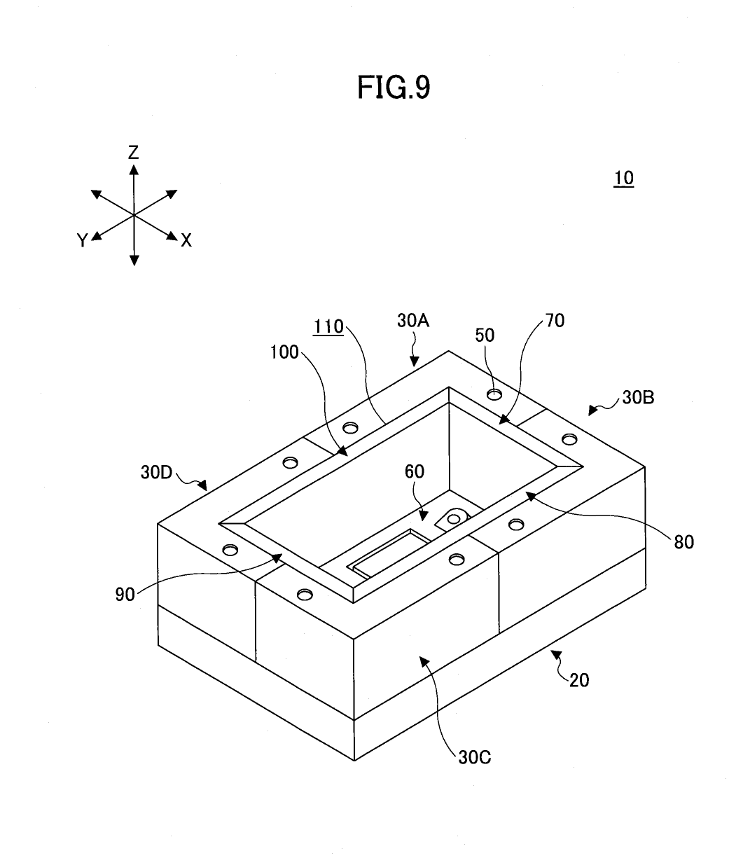

FIG. 8 is a partially cross-sectioned side view illustrating an assembling step 5 of the ceramic assembly. FIG. 8 is a view shown from an opposite direction from a direction seeing in FIG. 4 and FIG. 6. FIG. 9 is a perspective view illustrating the ceramic assembly when the assembling steps are completed.

As illustrated in FIG. 8, a fifth green ceramic component 100 is mounted on the upper surface 22 of the carbon substrate 20 and the inclined surfaces 30D1 and 30A1 of the carbon holding members 30D and 30A. As the fifth green ceramic component 100 is held at the inclined surfaces 30D1 and 30A1 of the carbon holding members 30D and 30A, the fifth green ceramic component 100 is stably held at a relative position with respect to the first green ceramic component 60. With this configuration, an assembling position of the first green ceramic component 60 and the fifth green ceramic component 100 can be set with a high degree of accuracy.

Subsequently, the binder solution H is applied between the first green ceramic component 60 and the fifth green ceramic component 100, between the second green ceramic component 70 and the fifth green ceramic component 100, and between the fourth green ceramic component 90 and the second green ceramic component 70. After applying the binder solution H between the first green ceramic component 60 and the fifth green ceramic component 100, between the second green ceramic component 70 and the fifth green ceramic component 100, and between the fourth green ceramic component 90 and the fifth green ceramic component 100, the binder solution H is dried to bond the first, second, fourth and fifth green ceramic components 60, 70, 90 and 100.

At this time, a part of the binder solution H drops in the pocket 40 provided at a position lower than the first, second, fourth and fifth green ceramic components 60, 70, 90 and 100. Thus, the first, second, fourth and fifth green ceramic components 60, 70, 90 and 100 are prevented from being bonded to the carbon substrate 20.

With the above steps, as illustrated in FIG. 9, a ceramic assembly 110 formed by bonding the five green ceramic components 60, 70, 80, 90 and 100 is held in the assembly jig 10. The ceramic assembly 110 is mounted on the carbon substrate 20 of the assembly jig 10, and is introduced into the sintering furnace while being held inside the carbon holding members 30A to 30D.

Further, the ceramic assembly 110 is sintered at a high temperature of more than or equal to 1400° C. in the sintering furnace.

After the sintering step, molten silicon (Si) or molten aluminium (Al) may be impregnated on a surface of the ceramic assembly 110 to fill in micropores with the silicon or aluminium at the surface of the ceramic assembly 110 in order to reinforce the strength and the resistance of the ceramic assembly 110. Thereafter, surface finishing or grinding is performed on the ceramic assembly 110. After surface finishing or grinding, in accordance with necessity, the ceramic assembly 110 is measured, washed, assembled with peripheral components or the like and then delivered as a product.

As such, by assembling the ceramic assembly 110 on the carbon substrate 20 of the assembly jig 10, the plurality of green ceramic components 60, 70, 80, 90 and 100 can be effectively bonded with each other. Further, an assembling accuracy of the bonded green ceramic components 60, 70, 80, 90 and 100 can be increased with the large size ceramic assembly 110.

Here, an example of the method of manufacturing the ceramic assembly 110 using the assembly jig 10 is explained.

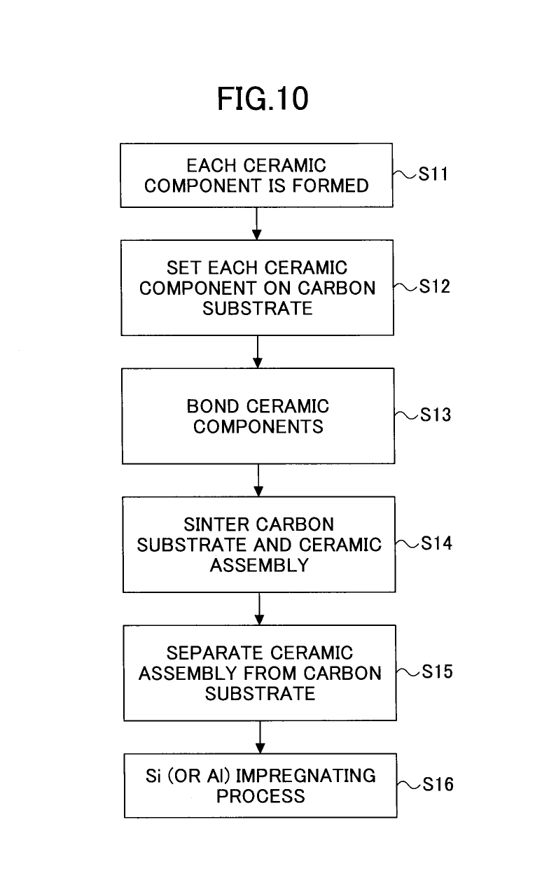

FIG. 10 is a flowchart for explaining the steps of the method of manufacturing the ceramic assembly.

As illustrated in FIG. 10, in step S11, each of the green ceramic components 60, 70, 80, 90 and 100 is formed into a predetermined shape. In step S12, each of the green ceramic components 60, 70, 80, 90 and 100 is set on the upper surface 22 of the carbon substrate 20, one by one.

In step S13, the green ceramic components 60, 70, 80, 90 and 100 are bonded with each other. Steps S12 and S13 are performed for each of the green ceramic components 60, 70, 80, 90 and 100.

Then, in step S14, the ceramic assembly 110 provided within the assembly jig 10 is introduced into the sintering furnace to be sintered.

In step S15, after completing the sintering step, the ceramic assembly 110 provided within the assembly jig 10 is carried out from the sintering furnace. Then, the bolts 50 are released to separate the carbon holding members 30A to 30D from the carbon substrate 20. With this configuration, the ceramic assembly 110 after being sintered can be easily taken out from the assembly jig 10.

In step S16, silicon (Si) or aluminium (Al) is impregnated on the ceramic assembly 110 after being sintered so that molten silicon or molten aluminium fill in micropores on the surface of the ceramic assembly 110. With this configuration, the strength and the resistance of the ceramic assembly 110 can be reinforced.

### ALTERNATIVE EXAMPLE 1

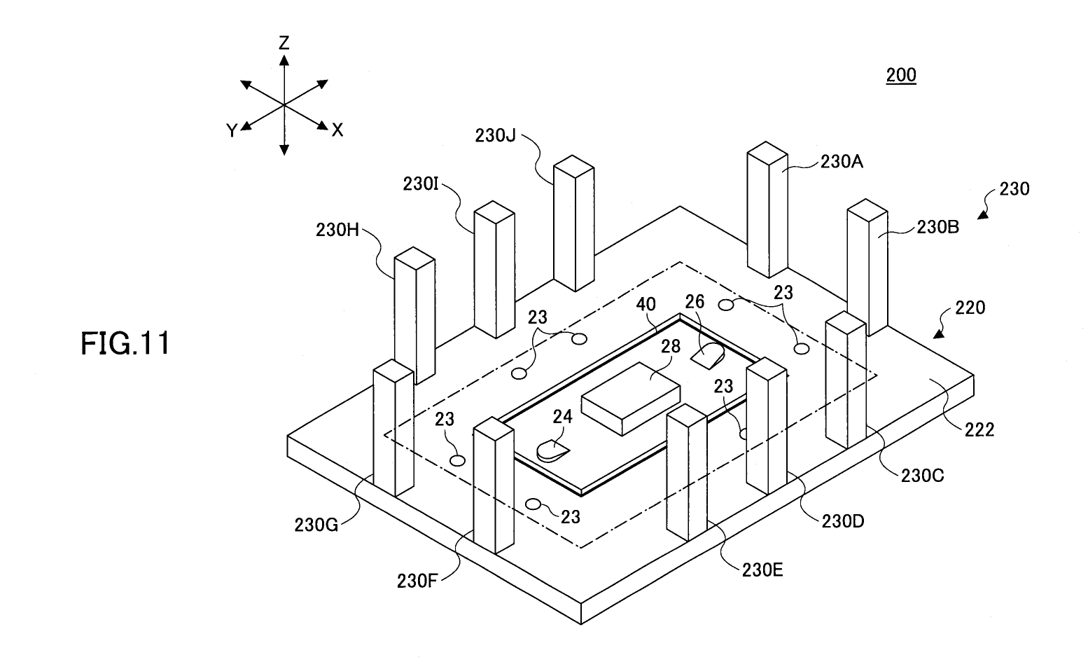

FIG. 11 is a perspective view illustrating an alternative example 1 of an assembly jig 200 that is used in the method of manufacturing a ceramic assembly. As illustrated in FIG. 11, the assembly jig 200 of the alternative example 1 includes a carbon fiber reinforced SiC substrate 220 instead of the carbon substrate 20 illustrated in the above embodiment. Similar to the carbon substrate 20, the carbon fiber reinforced SiC substrate 220 is provided with the screw holes 23 for fixing the carbon holding members 30A to 30D, the positioning portions 24, 26 and 28, and the pocket 40 provided on an upper surface 222 of the carbon fiber reinforced SiC substrate 220.

The assembly jig 200 further includes a plurality of metal holding members 230 (230A to 230J) that are provided around the periphery of the upper surface 222 of the carbon fiber reinforced SiC substrate 220. The metal holding members 230 (230A to 230J) are formed in a column shape. Here, positions for the metal holding members 230 and the number of the metal holding members 230 may be arbitrarily determined in accordance with the green ceramic components. Each of the metal holding members 230 may be made of stainless, for example. The metal holding members 230 may be provided when a force larger than a force provided for in the above explained embodiment is necessary for retaining the green ceramic components.

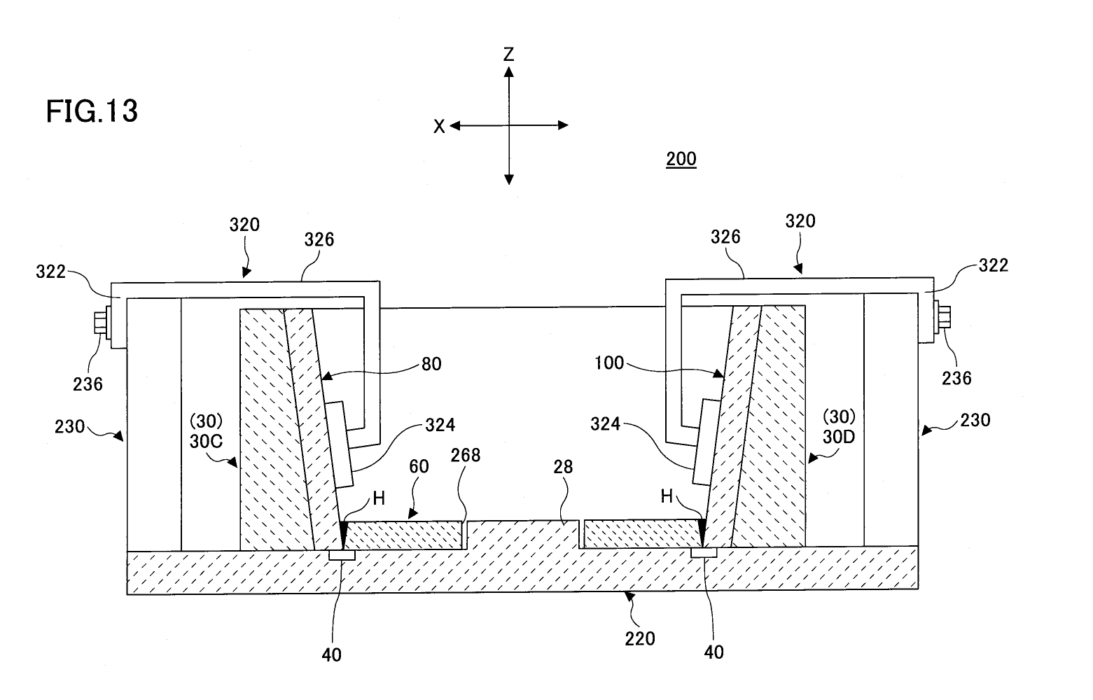

FIG. 13 is a partially cross-sectioned side view illustrating a structure of a holding member that is applied to the carbon fiber reinforced SiC substrate 220 of the alternative example 1.

In this example, the carbon holding members 30A to 30D (hereinafter, simply referred to as “30” as well) are also made of carbon fiber reinforced SiC.

As illustrated in FIG. 13, the green ceramic components 80 and 100 are supported by holding members 30 (illustrated as 30C and 30D) and the metal holding members 230, respectively. Second contacting members 320 are provided at upper ends of the metal holding members 230.

The second contacting members 320 are provided with a base end portion 322 that is fixed to an upper end side surface of the metal holding member 230 by a fastening member 236 and a front end portion 324 that contacts an inner periphery surface of the green ceramic component 80 or 100. The second contacting members 320 further include an arm portion 326 that passes over the green ceramic component 80 or 100 and supports the front end portion 324.

In this example, each of the green ceramic components 80 and 100 is supported by the holding member 30 that contacts an outer periphery surface and the second contacting member 320 that contacts the inner periphery surface. Thus, an assembling position of each of the green ceramic components 80 and 100 is determined at a high degree of accuracy by the holding member 30 and the second contacting member 320 that is fixed to the metal holding member 230.

At least portions of the front end portion 324 of the second contacting member 320 that contact the inner periphery surface of the green ceramic component 80 and 100 are made of resin materials.

Although not illustrated, the green ceramic components 70 and 90 are similarly supported by the holding members 30 and the metal holding members 230.

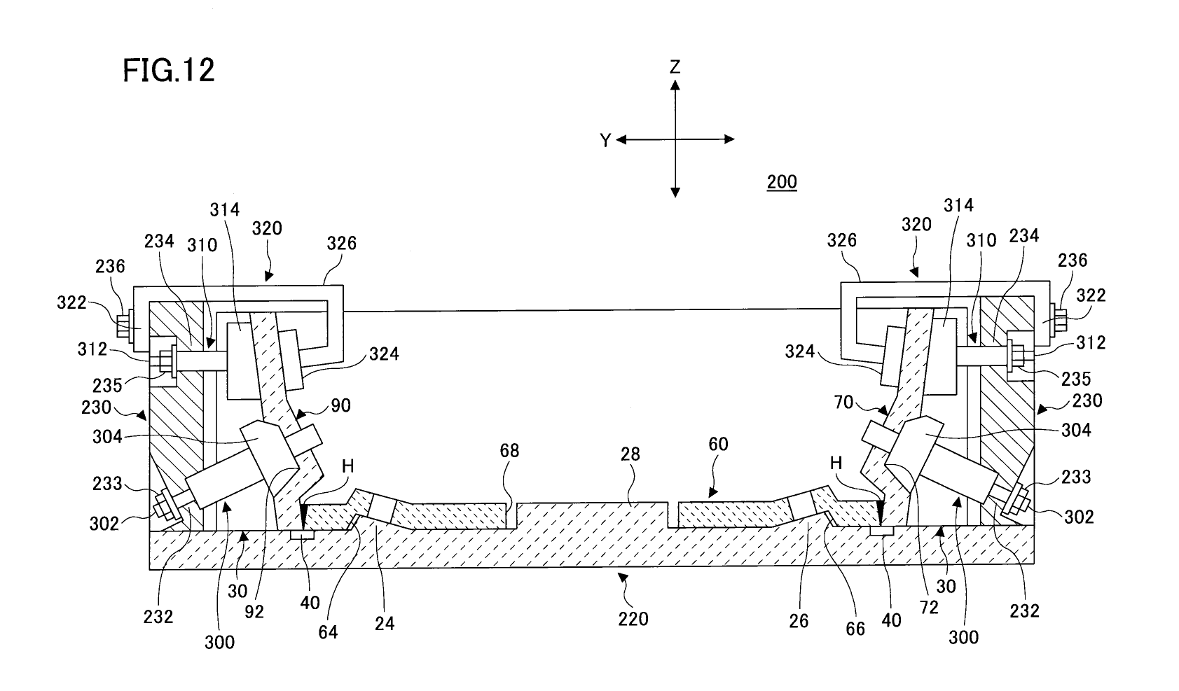

FIG. 12 is a partially cross-sectioned front view illustrating another example of a holding member that is applied to the carbon fiber reinforced SiC substrate 220 of the alternative example 1.

As illustrated in FIG. 12, in this example, the green ceramic components 70 and 90 have concave portions 72 and 92, respectively, for mounting cameras. The concave portions 72 and 92 are provided with mounting surfaces to which the cameras as components to be mounted are mounted. Each of the mounting surfaces has an inclined surface including an inclined angle in the X direction and an inclined angle in the Y direction corresponding to an mounting angle of each of the cameras. Here, each of the inclined angles of the mounting surface in the X direction and the Y direction may be set at an arbitral angle in accordance with the mounting angle of each of the cameras, for example.

Each of the green ceramic components 70 and 90 is supported by a fitting member 300 and first and second contacting members 310 and 320 fixed to the metal holding member 230. The fitting member 300 is provided with a base end portion 302 that penetrates a lower fixing portion 232 of the metal holding member 230 and is fixed to the metal holding member 230 by a fastening member 233 such as a nut or the like.

The fitting member 300 is further provided with a front end portion 304 that has a shape corresponding to the concave portion 72 or 92 so that the green ceramic component 70 or 90 can be held without backlash, respectively. The angle of the mounting surface of the concave portion 72 or 92 may be arbitrarily determined based on an inclined angle of the lower fixing portion 232 of the holding member 230 and a shape of the front end portion 304 of the fitting member 300.

The first contacting member 310 is provided with a base end portion 312 that penetrates an upper fixing portion 234 of the metal holding member 230 and is fixed to the metal holding member 230 by a fastening member 235 such as a nut or the like and the front end portion 314 contacts an outer periphery surface of the green ceramic component 70 or 90.

Similarly as described above, the second contacting member 320 is provided with the base end portion 322 that is fixed to the upper end side surface of the metal holding member 230 by the fastening member 236 and the front end portion 324, supported by the arm portion 326 that passes over the green ceramic component 70 or 90, that contacts the inner periphery surface of the green ceramic component 70 or 90. Thus, each of green ceramic components 70 and 90 is supported by the first contacting member 310 that contacts an outer periphery surface and the second contacting member 320 that contacts the inner periphery surface at a vicinity of its upper end surface. Therefore, an assembling position of each of the green ceramic components 70 and 90 is set at a high degree of accuracy by the fitting member 300 and the first and second contacting members 310 and 320 that are fixed to the metal holding member 230.

At least portions of the front end portion 304 of the fitting member 300, the front end portion 314 of the first contacting member 310 and the front end portion 324 of the second contacting member 320 that contact the outer or inner periphery surface of the green ceramic component 70 or 90 are made of resin materials. If metal contacts the ceramics and adheres to the ceramics, ceramic components after being sintered will change by the metal. Thus, a portion that contacts the ceramics may be made of a resin material.

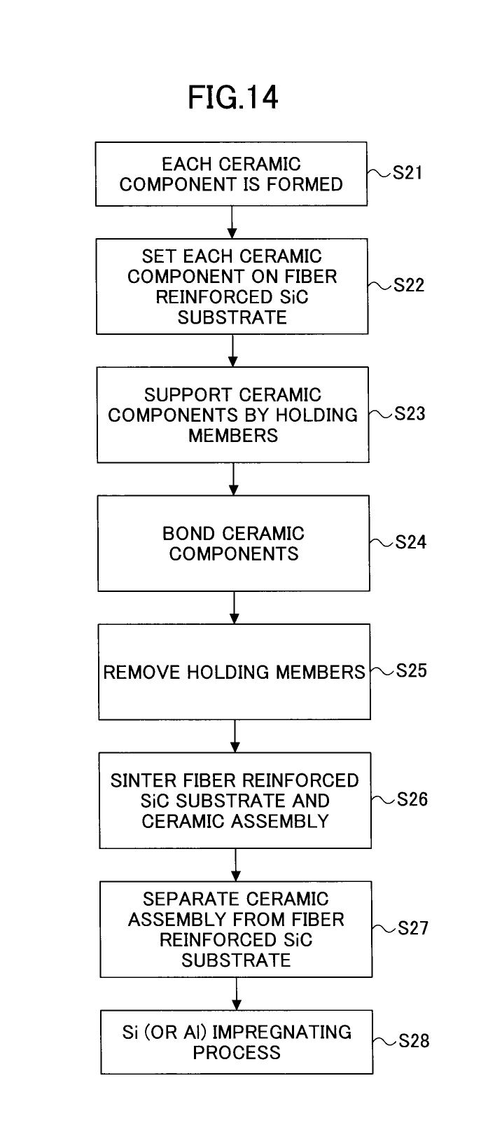

FIG. 14 is a flowchart for explaining steps of the method of manufacturing the ceramic assembly of the alternative example 1.

As illustrated in FIG. 14, in step S21, each of the green ceramic components 60, 70, 80, 90 and 100 is formed into a predetermined shape. In step S22, each of the green ceramic components 60, 70, 80, 90 and 100 is set on the upper surface 222 of the carbon fiber reinforced SiC substrate 220, one by one.

In step S23, when it is necessary to reinforce a retaining force for either of the green ceramic components 60, 70, 80, 90 and 100, the green ceramic component is supported by the metal holding member 230 and the second contacting member 320 (the fitting member 300, the first 310 contacting member 310 or the like) fixed to the metal holding member 230 to determine the assembling position.

In step S24, the green ceramic components 60, 70, 80, 90 and 100 are bonded with each other. Steps S22 to S24 are performed for each of the green ceramic components 60, 70, 80, 90 and 100.

In step S25, after bonding for the green ceramic components 60, 70, 80, 90 and 100 has been completed, the metal holding member 230 and the second contacting member 320 (the fitting member 300, the first 310 contacting member 310 or the like) are removed.

In step S26, the ceramic assembly 110 provided with the carbon fiber reinforced SiC substrate 220 (and the holding members 30) is introduced into the sintering furnace to be sintered.

In S27, after completing the sintering step, the ceramic assembly 110 with the carbon fiber reinforced SiC substrate 220 (and the holding members 30) is carried out from the sintering furnace.

In step S28, molten silicon (Si) or molten aluminium (Al) is impregnated on the ceramic assembly 110 after being sintered so that silicon or aluminium fill in micropores on the surface of the ceramic assembly 110. With this configuration, the strength and the resistance of the ceramic assembly 110 can be reinforced. Thereafter, surface finishing or grinding is performed on the ceramic assembly 110. After surface finishing or grinding, in accordance with necessity, the ceramic assembly 110 is measured, washed, assembled with peripheral components or the like and then delivered as a product.

### ALTERNATIVE EXAMPLE 2

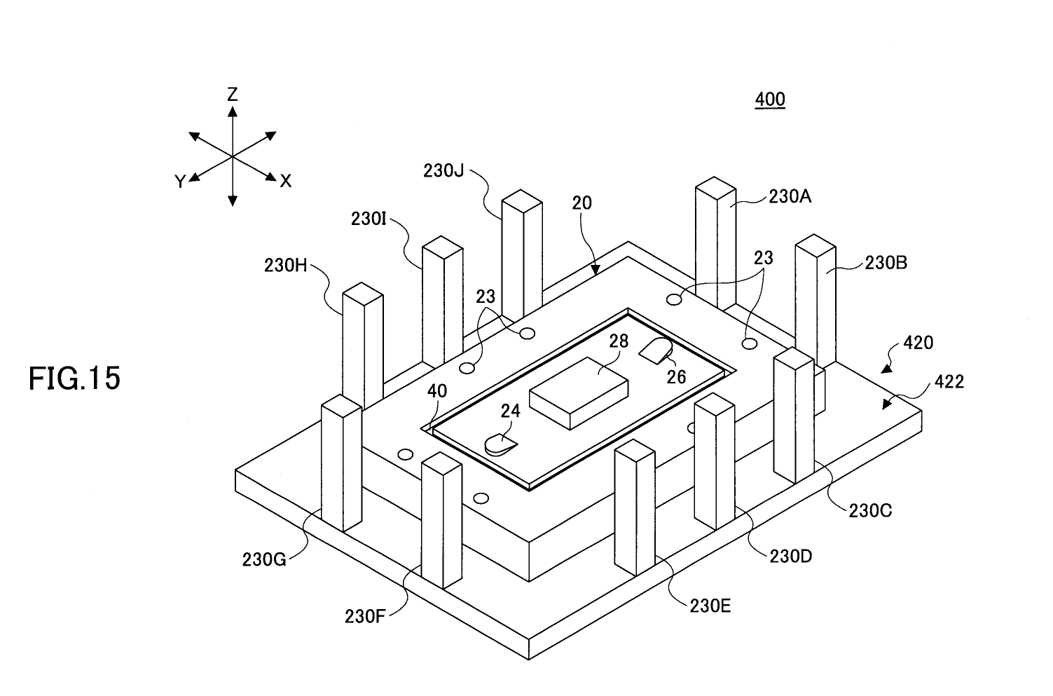

FIG. 15 is a perspective view illustrating an assembly jig 400 that is used in the method of manufacturing a ceramic assembly of an alternative example 2. As illustrated in FIG. 15, the assembly jig 400 of the alternative example 2 includes a metal base 420 and the carbon substrate 20 (see FIG. 1) is mounted on an upper surface 422 of the metal base 420. The metal base 420 is made of iron, for example. The assembly jig 400 is conveyed with the metal base 420 using a carrier.

The assembly jig 400 further includes the plurality of metal holding members 230 (230A to 230J) that are provided around the periphery of the upper surface 422 of the metal base 420.

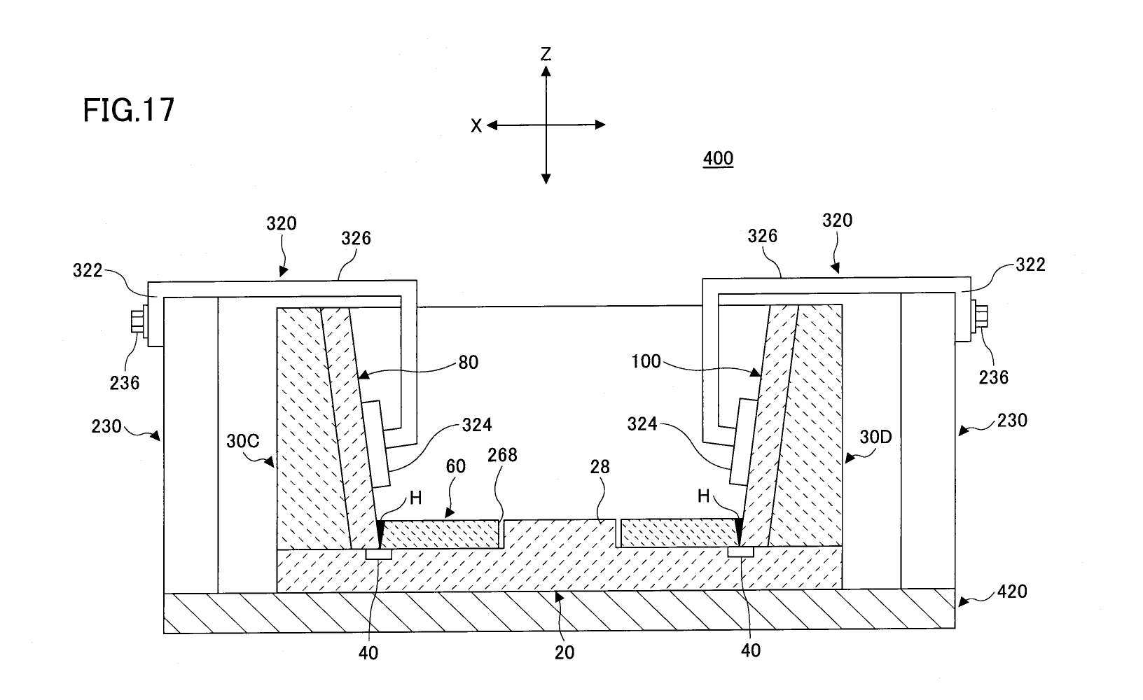

FIG. 17 is a partially cross-sectioned side view illustrating a structure of a holding member that is applied to a carbon substrate of the alternative example 2.

In this example, the carbon holding members 30A to 30D (hereinafter, simply referred to as “30” as well) are made of carbon.

As illustrated in FIG. 17, each of the green ceramic components 80 and 100 is supported by the holding member 30 that contacts the outer periphery surface of the green ceramic component 80 or 100 and the second contacting members 320 that contacts the inner periphery surface of the green ceramic component 80 or 100, respectively. Thus, the position of each of the green ceramic components 80 and 100 can be rigidly determined by the holding member 30 and the second contacting member 320 fixed to the metal holding member 230 with a high degree of accuracy.

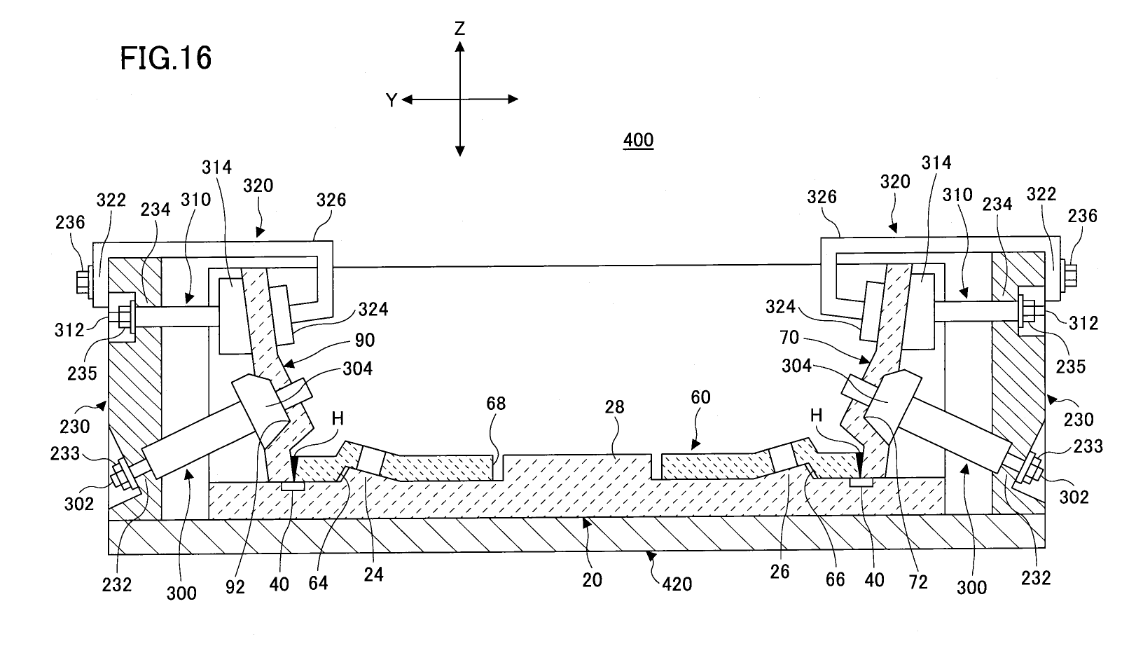

FIG. 16 is a partially cross-sectioned front view illustrating another example of a holding member that is applied to the carbon substrate of the alternative example 2.

As illustrated in FIG. 16, similar to the example as illustrated in FIG. 12 in the alternative example 1, the green ceramic components 70 and 90 have concave portions 72 and 92 for mounting cameras, respectively. Each of the metal holding member 230 is provided with the first and second contacting members 310 and 320.

In the case when the green ceramic components 70 and 90 are provided with the concave portions 72 and 92, respectively, the green ceramic components 70 and 90 are supported from the outside and inside by the first and second contacting members 310 and 320, respectively. Thus, the position of each of the green ceramic components 70 and 90 can be determined at a high degree of accuracy by the first and second contacting members 310 and 320 fixed to the metal holding member 230.

In this example, as the metal holding members 230 are fixed to the metal base 420, the rigidity can be increased compared with a case when the metal holding members 230 are fixed to the carbon substrate 20. Thus, the position of each of the green ceramic components can be rigidly determined with a high degree of accuracy as retaining the strength of each of the green ceramic components can be improved.

Further, after bonding and assembling the green ceramic components 60, 70, 80, 90 and 100 with the assembly jig 400, the metal base 420 is separated from the carbon substrate 20. Then, before the sintering step, the metal holding member 230 and the second contacting member 320 (the fitting member 300, the first contacting member 310 or the like) are removed. Then, the ceramic assembly 110 formed by assembling the green ceramic components 60, 70, 80, 90 and 100 is introduced into the sintering furnace with the carbon substrate 20 (and the holding members 30) to be sintered.

After completing the sintering step, the ceramic assembly 110 with the carbon substrate 20 (and the holding members 30) is carried out from the sintering furnace. Then, after removing the carbon substrate (and the holding members 30), the ceramic assembly 110 is transferred to a place where a silicon (or aluminium) impregnating step is performed, by a carrier or the like. Then, after completing the silicon (or aluminium) impregnating step, surface finishing or the like is performed on the ceramic assembly 110.

According to the above embodiment, it is possible to effectively assemble (bond) a plurality of green ceramic components that form a ceramic assembly. Thus, a large size ceramic assembly can be achieved and the assembling accuracy of the green ceramic components can be increased.

In the above embodiment, the ceramic assembly may be made of ceramics such as silicon carbide (SiC), silicon nitride (Si₃N₄) and the like. Thus, the method and the jig that are applicable to such ceramics are explained. As for ceramics, non-oxide type ceramics such as AlN, TiN and the like may be used and the same method may be used for such ceramics as well. For a material of the jig, in addition to carbon and carbon fiber reinforced SiC, other materials may be used provided that these materials have a heat resistance property and a coefficient of thermal expansion close to that of ceramics.

Further, in the above embodiment, an example is described in which the camera is mounted at the concave portion of the ceramic assembly. However, a component to be mounted, other than the camera, may be mounted to the concave portion of the ceramic assembly.

Although a preferred embodiment of the method of manufacturing the ceramic assembly has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

What is claimed is:

1. A method of manufacturing a ceramic assembly by assembling a plurality of green ceramic components, comprising:
subsequently mounting each of the plurality of green ceramic components on a heat resistant substrate made of a heat resistant material;
bonding the plurality of green ceramic components mounted on the substrate with each other; and
introducing a ceramic assembly formed by the plurality of green ceramic components bonded with each other into a sintering furnace while being mounted on the heat resistant substrate.

2. The method of manufacturing the ceramic assembly according to claim 1,
wherein the heat resistant material is carbon.

3. The method of manufacturing the ceramic assembly according to claim 1, further comprising:
impregnating silicon or aluminium on a surface of the ceramic assembly after being sintered in the sintering furnace.

4. The method of manufacturing the ceramic assembly according to claim 1,
wherein the heat resistant substrate is provided with a positioning portion that determines a mounting position of at least one of the green ceramic components.

5. The method of manufacturing the ceramic assembly according to claim 1,
wherein the heat resistant substrate is provided with a holding member that holds at least one of the green ceramic components.

6. The method of manufacturing the ceramic assembly according to claim 5,
wherein the holding member is made of carbon that is fixed on the heat resistant substrate.

7. The method of manufacturing the ceramic assembly according to claim 5,
wherein the holding member or the heat resistant substrate is provided with a pocket so that, when bonding two of the green ceramic components that are mounted on the heat resistant substrate by binder solution, a bonding portion of the two of the green ceramic components does not contact the respective holding member or the heat resistant substrate.

8. The method of manufacturing the ceramic assembly according to claim 5,
wherein the holding member includes a fitting portion that fits an outer concave portion of the green ceramic component.

9. The method of manufacturing the ceramic assembly according to claim 8,
wherein the outer concave portion is provided with a mounting surface by which a position of a component to be mounted is set.

10. The method of manufacturing the ceramic assembly according to claim 9,
wherein the component to be mounted is a camera.

11. The method of manufacturing the ceramic assembly according to claim 9,
wherein the mounting surface has a predetermined inclined angle with respect to a base plane of the green ceramic component.

12. The method of manufacturing the ceramic assembly according to claim 1,
wherein the heat resistant substrate is mounted on a base made of metal that is provided with a holding member made of metal and fixed to the base, the holding member further being provided with an arm member that is fixed to the holding member and supports at least one of the green ceramic components by contacting inside and outside of the respective green ceramic component.

13. The method of manufacturing the ceramic assembly according to claim 12,
wherein the heat resistant substrate is a carbon substrate.
